(19) United States
(12) Patent Application Publication
(10) Pub. No.: US 2019/0279272 A1
(43) Pub. Date: Sep. 12, 2019

(54) System and Method for Food Sharing

(71) Applicant: JustAnotherApp, LLC, Holladay, UT (US)

(72) Inventor: Sonia Pal, Holladay, UT (US)

(21) Appl. No.: 16/299,686

(22) Filed: Mar. 12, 2019

Related U.S. Application Data
(60) Provisional application No. 62/641,811, filed on Mar. 12, 2018.

(51) Int. Cl. G06Q 30/06; G06Q 10/08; G06Q 20/06; G06Q 50/12

(52) U.S. Cl. CPC G06Q 30/0627; G06Q 30/0633; G06T 19/006; G06Q 20/06; G06Q 50/12; G06Q 10/087

(57) ABSTRACT

A food sharing system comprises a server configured to receive, store, process, analyze, and/or provide information about food availability, food requests/searches, availability of food preparation facilities, and requests/searches for food preparation facilities. The server may provide to a user, in response to a request/search, options for food and/or food preparation facilities. When a user makes a selection, the server may facilitate a transaction for reserving and/or paying for food, food-sharing related goods or services, and/or food preparation facilities. Compensation in such transactions may include money, currency, services, credits, and/or combination of such.

### BACKGROUND OF THE INVENTION

In today's society, people are busy. Often, people are so busy that they do not have time to prepare food and/or to socialize. Ironically, even with the significant desire that many people have to experience good food and good society, and the close proximity in which many people live, much food goes to waste because it is too much for one or a few people to eat, people settle for low quality food or for a lack of variety in food, and many social connections are never made. Additionally, another obstacle to making social connections is lack of familiarity with new people, including security concerns as to another's intentions, character, or behaviors. This further dissuades people from meeting new people, especially in potentially compromising situations such as a non-public place like a private residence.

What is needed is a way for people to share food, food preparation ability, and food preparation capacity, and further to make social connections over food and/or food experiences.

### BRIEF SUMMARY OF THE INVENTION

An exemplary system for food sharing may comprise a central server for receiving, storing, processing, analyzing, and providing information related to food sharing. One or more users may transmit food-sharing-related information to and receive food-sharing-related information from the central server.

The central server may store user information comprising role, location, eating/food preferences, demographics, cooking ability, cooking capacity, cooking availability, eating ability, and accommodation capacity.

The central server may receive, store, process, analyze, and/or provide information relating to food availability for food prepared by a user. Food availability may relate to food that is already prepared, or to food that may be prepared or otherwise available in the future.

The central server may also receive, store, process, analyze, and/or provide requests/searches for food. Based on a food request/search, the central server may provide to a user options for obtaining food, and may facilitate a transaction whereby a requesting user may purchase food from a preparing user. Provided food options may include, e.g., augmented reality.

The central server may be configured to facilitate ranking and/or rating of users, food, attributes of food eating experiences, and other attributes related to food sharing, e.g., freshness or delivery. In one embodiment, food may be sold auction-style, or under a barter system. Bartering may comprise an exchange of food for services, e.g., lawn mowing or cooking lessons.

The central server may also receive, store, process, analyze, and/or provide information related to use and availability of food preparation facilities, e.g., food preparation facilities that are unused during restaurant slow times, or food preparation co-working spaces. For example, the central server may store information about availability of food preparation facilities, e.g., for rent. Such information may include, e.g., location, times, dates, equipment, cost, human resources, and food inventory. A user may transmit to the central server a search request for food preparation facilities. The central server may respond by providing options for available food preparation facilities, and may further facilitate a transaction by which a user may reserve and provide compensation for food preparation facilities.

The central server may further be configured to receive, store, process, analyze, and/or provide information related to inventory for food preparation facilities. For example, when a user searches for and/or finds a food preparation facility, the central server may provide information about equipment, disposable goods, and ingredient inventory available at or in conjunction with the food preparation facility. The central server may further be configured to allow a user to request inventory, e.g., food ingredients, and to order and have delivered such inventory from an online or brick-and-mortar retailer.

In one embodiment, the central server may use artificial intelligence to make suggestions to users about, e.g., available food that may be desirable, or food to prepare for which there may be demand, and other food-sharing relating opportunities, issues, or circumstances.

The central server may further be configured to receive, store, process, analyze, and/or provide information relating to background checks on users and food preparation/handling licensing and compliance.

The food sharing transactions as disclosed herein may use, as payment for food or food-sharing-related services, money, currency, credits, food, and/or other compensation/remuneration.

### BRIEF DESCRIPTION OF THE DRAWINGS

FIG. 1 illustrates an exemplary food sharing system.

FIG. 2 illustrates an exemplary method for food sharing.

FIG. 3 illustrates an exemplary method for food sharing using a credits payment paradigm.

### DETAILED DESCRIPTION OF THE INVENTION

This application claims priority to U.S. Provisional Application No. 62/641,811, titled “System and Method for Food Sharing,” the first inventor of which is Sonia pal, which was filed on Mar. 12, 2018, and which is incorporated herein by reference in its entirety.

A system and method are disclosed for facilitating sharing of food preparation ability and capacity, as well as facilitating social and eating experiences over food.

### TABLE OF REFERENCE NUMBERS FROM DRAWINGS

The following table is for convenience only, and should not be construed to supersede any potentially inconsistent disclosure herein.

| Reference Number | Description |
|---|---|
| 100 | exemplary system for providing food |
| 120 | network |
| 140 | food provider |
| 160 | food consumer |
| 182 | direction of food transfer |
| 184 | direction of money transfer |
| 200 | exemplary method |
| 210 | step in exemplary method 200 |
| 220 | step in exemplary method 200 |
| 230 | step in exemplary method 200 |
| 240 | step in exemplary method 200 |
| 250 | step in exemplary method 200 |
| 260 | step in exemplary method 200 |
| 300 | exemplary method |
| 310 | step in exemplary method 300 |
| 320 | step in exemplary method 300 |
| 330 | step in exemplary method 300 |
| 340 | step in exemplary method 300 |
| 350 | step in exemplary method 300 |
| 360 | step in exemplary method 300 |
| 370 | step in exemplary method 300 |
| 380 | step in exemplary method 300 |

Food Sharing

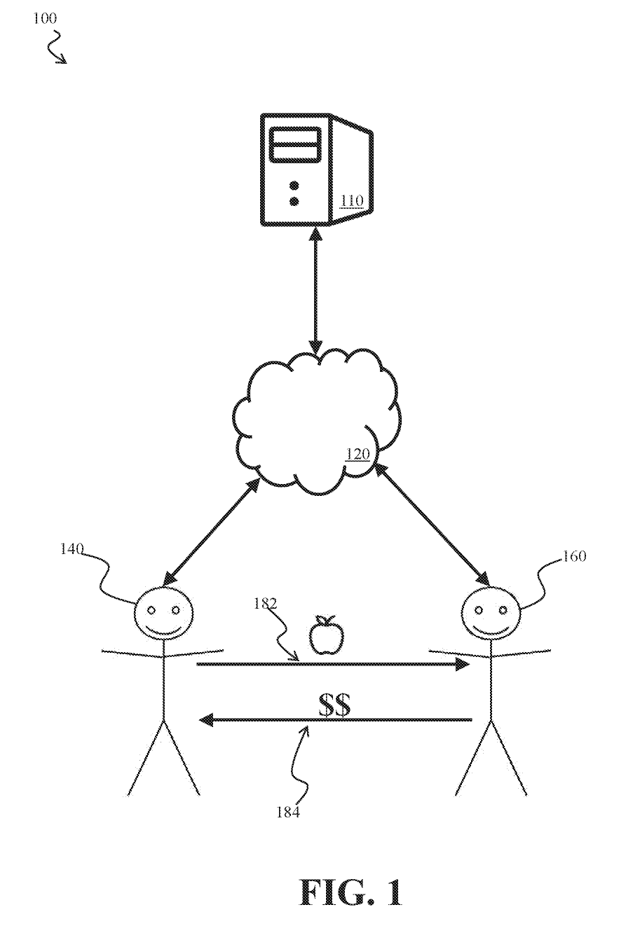

FIG. 1 illustrates an exemplary system for sharing food. As showing in FIG. 1, a central server 110 may receive, store, analyze, process, and provide information to facilitate food sharing and social experiences over food. For example, central server 110 may store user information, food availability information, and other information. Central server 110 server may be virtual, or hardware, or a combination of virtual and hardware, cloud implemented, partially cloud implemented, distributed, non-distributed, a combination of any of these, and/or any other server solution known in the art.

Users

As shown in FIG. 1, one or more users 140 and 160 may transmit information to and receive information from central server 110. Such information may be transmitted over a network 120, which may be the Internet or any other network known in the art.

In one embodiment, central server 110 may store some or all of the following information for a user: (1) user role(s) (individual, family, group, company, food provider, food consumer, food deliverer, other entity or group); (2) user preferences (distance willing to travel to pick up or deliver food, willingness to eat/socialize with strangers or age groups or genders or other characteristics of individuals, group sizes in which user is comfortable, food preferences or aversions); (3) user characteristics (age, gender, height, weight, race, introvert/extrovert, occupation, home location, work location, hobbies and recreational activities, book genres, etc.); (4) cooking ability (genres, skill level, years of experience, formal education, informal education, etc.); (5) cooking capacity (amount of food that can be prepared in a particular amount of time, resources such as kitchen size and tools); (6) cooking availability (times of day, days of week, etc.); (7) eating ability (e.g., amount of food that a user is able to eat); (8) demographic information; (9) seating capacity at home or other location to which user has access.

Food Availability and Order Information

Central server 110 may additionally receive, store, process, analyze, and/or provide food availability and/or order information. For example, central server 110 may receive, store, process, analyze, and/or provide information relating to food availability including but not limited to: (1) description of food; (2) preparer of food; (3) location of food; (4) freshness window for food; (5) storability of food; (6) rating/review information for food or preparer of food; (7) amount of food; (8) price of food; (9) delivery availability, cost, and parameters for food; (10) availability of location for eating food, including, e.g., location, capacity of location, identity of other attendees or residents at location, rating of location, times available, rating/ranking of location; (11) transportability of food.

Central server 110 may transmit to and receive information from users 140 and 160 through an electronic device such as a smartphone (e.g., through an app), laptop computer (e.g., Internet browser interface or networked application), desktop computer, tablet, voice activated device (e.g., Amazon Alexa or Google Home) or any other electronic or computing device known in the art. In one embodiment, a smartphone may include an app configured to communicate with the central server. For example, the app may provide an interface to transmit information to central server 110 or to receive information from central server 110. For example, a user may determine that he/she has extra food, or that he/she is going to have extra food, or that he/she may make extra food if necessary, or that he/she otherwise has, or will have, or may have, available food. As described above, the user may provide through the app, or through any other interface known in the art, food availability information as described herein.

Food Requests

Central server 110 may also receive, store, process, analyze, and provide data and/or other information relating to searches, requests, or orders for food. For example, using a smartphone or other interface, a user may request, order, or search for food availability.

In one embodiment, user 160 may search for currently available food. Search criteria may include geographic location, food attributes (e.g., type, preparer, freshness, cost, location, rating/ranking, etc.), and other attributes described herein or known in the art. For example, a user may search based on the following criteria: (1) Mexican food (2) with a previous rating of at least four stars, (3) prepared by a user with a rating of at least four stars. (4) with an available window of 5:30 pm-7:30 pm, (5) with a freshness window of 5:30 pm-8:00 pm, (6) with a location within 1.5 miles of the user's route home from work, and (7) for a cost of less than $13.00. User 160 may submit such search criteria to central server 110 via network 120.

Central server 110 may receive search criteria from user 160, process the search criteria, prepare search results, and transmit search results to user 160 via network 120. Search results may be presented via a user interface that shows a map, or that ranks by attributes/criteria that the searching user may select. For example, search results may be ranked by food rating/ranking, preparer rating/ranking, deliverability attributes, cost, freshness, availability, location, availability for consuming food at preparer's residence or some other location, attributes of preparer or of others with whom food may be consumed, and/or health criteria (calories, salt, sugar, fat, etc.).

Based on the search results, user 160 may determine to purchase food from user 140 by making a selection through an interface such as a smartphone app, which will transmit the selection to central server 110. Central server 110 may be configured to use one of many e-commerce engines as are well-known in the art to effect any financial aspect of a transaction for user 160 to purchase food. Upon successful completion of a purchase transaction, a message may be sent to user 140 identifying attributes of the food purchase so that the user 140 can prepare, deliver, and/or perform other actions in response to user 160's food purchase.

In one embodiment, when reviewing search results, a searching user 160 may message a food-preparation-user 140 preparer to make a special request, e.g., “I see that you have one serving available. Any way that you could have three servings available?” or “Could you make a gluten-free version?” or any other request.

In another embodiment, a user 140 may input information to central server 110 through, e.g., a smartphone app, indicating availability to prepare food at the current time or at any time in the future. For example, user 140 may indicate, through a smartphone app, that he/she is available to make between one and twenty or his/her famous quesadillas on Mondays and Wednesdays at any time after 3:00 pm, and is available to prepare between one and ten of his/her award winning enchiladas on Mondays and Wednesdays at any time after 3:00 pm, if given at least four hours of notice. A user 140 may also post other attributes as described herein, e.g., availability of seating, delivery, cost, location, ratings/rankings of food and/or preparer, etc.

A user 160 may search for food that will be available in the future, and may then order such food. For example, at 10:00 on a Wednesday morning, a user 160 may search for all orderable food that could be ready at 5:30 pm that same day within a two-mile radius of user 160's residence. As described herein, a user 160 may search for orderable food based on many criteria and/or attributes.

In one embodiment, various aspects of the system described herein may be rated and/or ranked, and central server 110 may be configured to receive, store, analyze, process, and provide information for such ratings and/or rankings. Attributes or aspects that may be rated and/or ranked include but are not limited to food, preparers, eating locations/venues, delivery, and other attributes as described herein. For example, central server 110 may, through an app on user 160's smartphone (or other interface), solicit, or even require user 160 to provide a rating of food that he/she purchased, or cleanliness or comfort of an eating location or venue, or accuracy of provided freshness information, or friendliness of a preparer or other person (e.g., food delivery driver, company at eating venue), cost, value, timeliness, or any other attribute of food or the services disclosed herein. Based on such ratings and/or rankings, user 160 may search for food or preparers or services as described herein.

In some embodiments, the central server or other computing device may be configured to sort, or to support sorting of, or to filter, or to support filtering of, search results based on ratings/rankings.

In one embodiment, central server 110 may be configured to receive, store, process, analyze, and/or provide augmented reality information about food, locations, users, etc. For example, the central server may provide images, video, sounds, etc. of food, locations, users, etc. In some embodiments, a 3D representation of food, locations, users, etc. may be provided.

In another embodiment, central server 110 may store information relating to availability of food preparation facilities, e.g., commercial grade food preparation facilities or other types of food preparation facilities. Based on local food preparation and serving laws, regulations, and guidelines, and further based on user 140's needs for food preparation facilities or tools, or possibly even needs for skilled food workers or chefs, central server 110 may be configured to search for facilities, personnel, and chefs (or other assistants) for user 140. For example, user 140 may indicate that he/she is able to prepare 300 enchiladas if necessary. User 140 user may live in a small apartment by himself/herself. When user 140 receives an order for 300 enchiladas, e.g., four days in the future, then user 140 may search, using an interface provided through his/her smartphone app or other interface, for food preparation facilities that are available for the times he/she needs them, and for food preparation workers with the appropriate skill set to assist and/or otherwise support user 140 in fulfilling the order.

In one embodiment, food may be sold auction-style. For example, user 140 may indicate to central server 110, through an app on his/her smartphone, that he/she will have 10 servings of homemade spaghetti available at 7:00 pm that evening, and that this spaghetti will be sold to the highest bidder(s) in the next 20 minutes or during some other time frame, e.g., as a food freshness window. Central server 110 may facilitate user bidding through smartphone apps or other interfaces, and may award purchasing rights to users who win the bidding scheme.

In another embodiment, system 100 as described herein may be configured to facilitate and/or support bartering, e.g., offering something other than money in exchange for food or other goods or services as described herein. For example, user 160 may indicate that he/she is willing to mow a lawn in exchange for a good meal on a particular evening.

In another embodiment, user 140 may offer a service of teaching another how to prepare food, e.g., at the user's home, or at another location, or online.

In another embodiment, system 100 as disclosed herein may employ an artificial intelligence technology to suggest food, preparers, locations, company, costs, dates/times, and other food and/or services to a user. Central server 110 may be configured with logic and/or computer instructions to implement artificial intelligence technologies and/or approaches. For example, system 100 may send, via central server 110, a push notification to a user 160's smartphone informing user 160 that “Juan's quesadillas, which you rated as five stars two weeks ago, will be available in two hours.”

In another embodiment, central server 110 may be configured to receive, store, process, analyze, and/or provide store background check or background check information for users, and may provide background check information to other users, e.g., before a first user buys food from a second user, or before a first user meets a second user in person, or before a first user visits a second user's home.

In another embodiment, central server 110 may be configured to receive, store, process, analyze, and/or provide information regarding licensing, compliance with food handling standards, inspections, etc. The system may provide such information to other users, or may use such information to generate ratings or rankings, or may disable users based on compliance issues, or may require inspections, etc.

In one embodiment, central server 110 may be configured to receive, store, process, analyze, and/or provide information for renting out or otherwise using unused, or underused, restaurant or food preparation facilities or space. Many restaurants and food preparation services, businesses, and facilities are under-utilized, e.g., in the morning, afternoons, or at other slower times. Central server 110 may be configured to receive, store, process, analyze, and/or provide information representing available food preparation resources. For example, such information may include some or all of: location, specific facilities available, size, certifications or licenses for the facility, certifications or licenses necessary for a third party to use the facilities, availability schedule, rental pricing (which may be dynamic depending on timing, advance notice, uses, and other factors), human resources available in association with such food preparation facilities, and other information regarding food preparation resources and/or facilities.

Central server 110 may be configured to make rental information for food preparation facilities available through a user interface, e.g., through a website, app, software, or other interface known in the art, and to further make such rental information searchable. Rental information for one or more food preparation facilities may reflect food preparation facilities that are owned and rented out by an individual or entity that is in the business of owning and renting out co-working spaces, e.g., specifically food preparation facilities and/or food preparation co-working spaces.

Central server 110 may also be configured to receive, store, and provide information for people or entities who are looking for food preparation facilities. This information may be similar to the information for renting out food preparation facilities. For example, such information may include, but is not limited to, desired location (or a range of locations or acceptable area), needed/desired facilities, size of needed/desired space, necessary/desired certifications or licenses, certifications or licenses of the person or entity seeking food preparation facilities, necessary/desired times, target or acceptable rental price, length of rental agreement, and other factors that may be significant for a person or entity seeking food rental space.

Central server 110 may also be configured to make such information, i.e., information about those seeking food preparation facilities, available through a user interface, e.g., through a website, app, software, or other interface known in the art, and to further make such information searchable.

Central server 110 may additionally be configured to receive, store, process, analyze, and/or provide information relating to food co-working spaces. This may be similar to food preparation facilities, except that food-coworking spaces may include the possibility of working alongside or in the vicinity of another food preparer. Some food preparers may find it beneficial to have the ability to ask questions or to watch other food preparers.

Inventory

In one embodiment, central server 110 may be configured to receive, store, process, analyze, and/or provide information relating to food and/or equipment inventory in a food preparation facility or co-working facility. For example, central server 110 may store an inventory of food preparation equipment on hand, and may allow users to search such equipment, view details of such equipment, reserve such equipment, check out such equipment, and/or any other action that a user may desire to do relative to such equipment. Additionally, central server 110 may be configured to allow a user, e.g., a person who uses or may use a facility, or an owner of a facility, or a manager of a facility, to order replacement or new inventory. For example, central server 100 may be configured to make orders electronically over a network, e.g., over the Internet from an online source such as Amazon.com.

Central server 110 may additionally be configured to receive, store, process, analyze, and/or provide information relating to consumable inventory, e.g., food or disposable food preparation or storage items. For example, central server may store inventory for fresh milk on hand in a rental or co-working space, or flour or other ingredients, and may further be configured to allow a user to reserve ingredients, pay for ingredients, and/or order new ingredients.

For example, central server 110 may be configured to allow a user, through the user's electronic device, e.g., a smartphone, to make an advance order of ingredients, equipment, disposable goods, or other items that a user may need. A user may be a renter of a food-preparation facility, and may determine that he/she needs ingredients to make burritos at the food-rental facility at 5:00 pm on Tuesday. On Tuesday morning at 8:00 am, the user may use an app on his/her smartphone that communicates with central server 110 to order food or other items that may be delivered prior to 5:00 pm that day, so that such food or other items are ready for user when user arrives at the food preparation facility to prepare burritos. For example, user may order ten heads of lettuce, 25 roma tomatoes, 200 flour tortillas, ten pounds of ground beef, and 100 ounces of refried beans, and five pounds of cheese. Central server 110 may be configured to provide e-commerce services, or may be configured to transmit or forward data or requests to other network-accessible computers or servers that may provide e-commerce services. For example, central server 110 may forward a user's order to an online grocery store for fulfillment.

In one embodiment, an entity may negotiate advantageous rates and/or purchase prices that may be made available to a user through central server 110 or otherwise.

In one embodiment, central server 110 may be configured to, in addition to facilitate ordering and/or inventory services for food and equipment, facilitate rental or purchase of human resources. For example, a user may order two assistant cooks with basic food preparation experience for three hours on Tuesday from 5:00 pm-8:00 pm. Central server 110 may store a database of people, including skillsets, experience, hourly rates, locations, personal characteristics, and other information that may be noteworthy to a user desiring assistance in preparing food or in other tasks relating to preparing and/or providing food. Central server 110 may make searching and related functionality available to a user for searching, identifying, requesting, reserving, rating, and paying other people for services related to food preparation.

In another embodiment, central server 110 may be configured to receive, store, process, analyze, and/or provide information about food consumption facilities, food delivery services, and/or food pickup facilities. For example, a food preparer may need a place for food purchasers to consume the food. In some circumstances, it may be desirable to a food preparer or food consumer to have multiple or different or new places to consume food. For example, a food preparer may have a reputation for making the best tacos in town. Instead of, or in addition to, a fixed location for selling his or her food, the food preparer may rent out interesting locations, or variable locations, for his/her food, and may provide an opportunity for food consumers to consume his/her tacos at the different location on different days. For example, the food preparer may rent out space at a park, or a museum, or a meeting hall, or a community meeting space, or any other location.

Central server 110 may be configured to receive, store, process, analyze, and/or provide information about food consumption facilities/locations, delivery services/options, and/or pickup facilities. A food preparer or provider may input such information to central server 110 through a website, app. software, or other data upload interface known in the art.

Central server 110 may also be configured to provide search functionality for such information. Such search functionality may be provided through an interface as may be known in the art and/or as otherwise disclosed herein.

Payment for Food

Central server 110 may be configured to facilitate payment or compensation for food. For example, central server 110 may itself be configured to accept and facilitate electronic payments, or to use a third-party service for electronic payments, or to redirect to a service for facilitating payments.

In one embodiment, central server 110 may facilitate a conventional payment system in which food purchase 160 provides money or a similar currency to food provider 140 in exchange for food or a service related to food.

In another embodiment, food purchaser 160 may provide food in exchange for food. This could be an actual exchange of food.

Alternatively, a food-for-food exchange could be facilitated, in whole or in part, using a credits scheme or paradigm. For example, a number of credits (or other food-valuation metric), may be assigned to food. The number of credits may be based on many factors, including but not limited to: a subjective evaluation of the food, an objective evaluation of the food, a voting system in which multiple purchasers of food (e.g., over time, from the same batch, or from a different batch of food) have provided a subjective valuation of the food, an analysis of the cost of ingredients (e.g., food containing lobster is likely to be more expensive than basic bread), convenience in purchasing, picking up, and/or consuming the food, freshness of the food, reputation of the food preparer, the timing of the food preparation, pickup, and/or consumption (e.g., whether the food was prepared on a busy day, weekday, weekend, holiday, etc., and the time of day at which the food was prepared), history with food preparer 140, food deliverer, or other food handler with food safety issues and/or violations, and any other factors that may affect the value of food and/or convenience or desirability in finding, ordering, obtaining, storing, and/or consuming the food.

Such credits may be accrued, purchased, or acquired in various ways. For example, user 140 may provide to central server 110 information reflecting that user 140 will prepare and make available tacos at a first location at 5:00 pm on Monday, January 15. User 140 may himself/herself indicate the credits value for such tacos, or the another person or entity may determine a credits value for such tacos, or central server 110 may determine a credits value for the tacos. The credits value of the tacos may be six credits per taco, i.e., a user 160 who wishes to consume the tacos must exchange six credits per taco that user 160. User 140 may be credited six credits per taco provided to user 160.

Central server 110 may be configured to facilitate, store, and track accounting for exchanges and transfers of credits. For example, on the morning of Monday, January 15, user 140 may begin the day with 117 credits, and user 160 may begin the day with 75 credits. As described herein elsewhere, central server 110 may facilitate a transaction whereby user 160 transfers 24 credits to user 140 in exchange for four tacos. Central server 110 may facilitate this transaction, and store information to memorialize this transaction, and may maintain an accounting showing that, after this transaction, user 140 has 141 credits and user 160 has 51 credits.

In this manner, food preparers and food consumers may exchange credits for food. In one embodiment, acquisition of credits may be fully or partially limited to preparing and providing food. Alternatively, credits may be purchased or acquired in ways other than by providing food to others.

In one embodiment, central server 110 may facilitate a credits-only ecosystem in which all participants must provide food at some point to one or more other participants to accrue credits for themselves to acquire food.

Credits may have an expiration or devaluation schedule. For example, credits may expire after 180 days, or may be subject to a devaluation schedule.

In another embodiment, central server 110 may facilitate a system in which food provider 140 receives work from user 160 in exchange for food. For example, central server 110 may be configured to receive, store, process, analyze, and/or provide information regarding work that user 160 desires to exchange for food. In one example, user 160 may be willing to provide lawn care service and may, through an interface, provide to central server 110 details regarding the available service(s) and the parameters of the food to be provided in return. Lawn care provider 160 may indicate that he/she is willing to mow a lawn on a particular day in a particular location in exchange for a lunchtime meal on those days. Central server 110 may make this information available and/or searchable to food provider 140 through an interface, e.g., a website, app, software, or other interface.

In another embodiment, central server 110 may be configured to receive, store, process, analyze, and/or provide information to facilitate exchange of cooking or food preparation lessons or instruction. Recipients of such lessons may provide, in exchange for such lessons, money, credits, food, and/or services. A user 140 desiring to provide lessons may provide, to central server 110, information regarding lesson availability. Such information may comprise, e.g., instructor, subject matter, level, days/times available, desired commitment (e.g., number of lessons that will be provided), cost, location, pre-requisites, and other information that may relate to lesson availability. User 140 may provide this information to central server 110 through an interface such as a web page, app, software or other interface. Central server 110 may make this information available, and may further provide search functionality for lesson availability.

Just as user 140 may offer lessons and may transmit to central server 110 information regarding lesson availability, a user 160 may also transmit to central server 110 information regarding desired lessons, i.e., a search to find lessons on a particular subject, e.g., sushi making.

In one embodiment, central server 110 may be configured to receive, store, process, analyze, and/or provide information to facilitate context-sensitive ads relating to food preparation. For example, a user may use an app on his/her smartphone, in communication with central server 110, to search, identify, request, and/or schedule a food-for-lesson transaction. In the process of using his/her smartphone to do so, central server 110 may transmit information to the user's smartphone indicating that that smartphone may display, or otherwise provide, an ad, e.g., a pop-up ad, for food and/or equipment relating to the food-for-lesson and/or other transaction being processed.

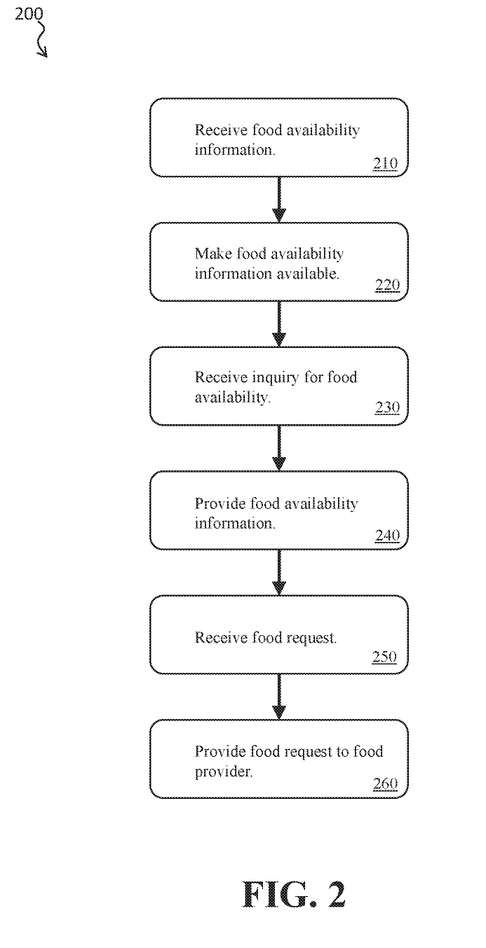

FIG. 2 is a flowchart illustrating an exemplary method 200 for food sharing.

At step 210, central server 110 may receive food availability information. In one embodiment, the food availability information may be received from user 140.

At step 220, central server 110 may make the food availability information available to one or more users of system 100.

At step 230, central server 110 may receive a food availability inquiry. This request may be received from user 160. This request may comprise a search, filter, or request for specific information. In some embodiments, central server 110 may not receive a request for food availability information, but may instead push some food availability information to one or more users based on such users' preferences, characteristics or attributes, or past decisions or actions.

At step 240, central server 110 may provide some or all of the food availability information to user 160.

At step 250, central server 110 may receive a food request from user 160.

At step 260, central server 110 may provide the received food request to user 140.

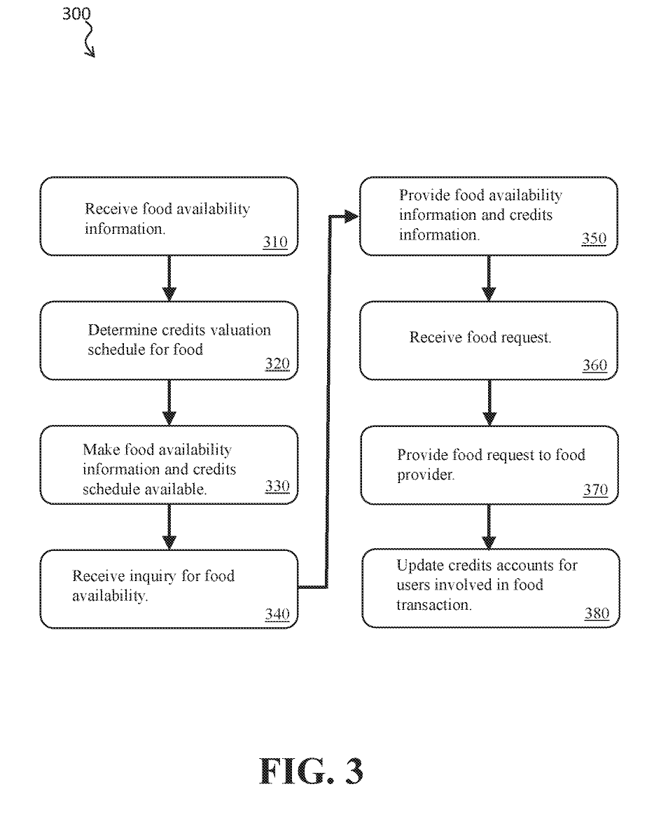

FIG. 3 is a flowchart illustrating an exemplary method for food sharing using a credits scheme.

At step 310, central server 110 receives food availability information. This food availability information will frequently be received from a food provider, e.g., user 140, but may be received from other sources.

At step 320, central server 110 determines a credits valuation schedule for food associated with the received food availability information.

At step 330, central server 110 may make food availability information and credits valuation schedule available to one or more users of system 100.

At step 340, central server 110 receives a food availability inquiry. This inquiry will frequently be received from a user 160, but may also be received from other sources. This request may comprise a search, filter, or request for specific information. In some embodiments, central server 110 may not receive a request for food availability information, but may instead push some food availability information to one or more users based on such users' preferences, characteristics or attributes, or past decisions or actions.

At step 350, central server 110 may provide some or all of the food availability information to user 160, and may additionally provide a credits schedule associated with the provided food availability information.

At step 360, central server 110 may receive a food request from user 160.

At step 360, central server 110 may provide the received food request to user 140.

At step 370, central server 110 may update user 140's credits account to reflect an addition of credits resulting from providing food to user 160.

At step 370, central server 110 may update user 160's credits account to reflect a subtraction of credits resulting from receiving food from user 140.

What is claimed is:

1. A server comprising non-transitory computer-readable instructions configured to:
receive a food inquiry; and
provide, based at least in response to the food request, food availability information;

2. The server of claim 1, wherein the food inquiry comprises a search for available food.

3. The server of claim 2, where the search for available food comprises at least one search parameter from the following food search parameters: type, health criteria, chef identify, chef rating, chef skill level, preparation location, freshness information, pickup location availability, pickup time availability, delivery availability, desired characteristics for consumption environment, desired characteristics for consumption location, and desired characteristics for consumption company.

4. The server of claim 1, wherein:
food availability information comprises at least a first available food option; and
the first available food option comprises, for a first available food, a description, availability time information, and availability location.

5. The server of claim 4, wherein the first available food option further comprises at least one from the following food option elements for the first available food: rating, chef characteristics, chef experience, chef rating, delivery options, cost, freshness, consumption option location information, consumption environment information, consumption company information, and health criteria.

6. The server of claim 1, wherein the computer-readable instructions are further configured to receive food availability input.

7. The server of claim 1, wherein food availability input comprises a description of a first available food, time information for the first available food, and location information for the first available food.

8. The server of claim 1, wherein the computer-readable instructions are further configured to receive a food request comprising a selection based on the provided food availability information.

9. The server of claim 8, wherein the computer-readable instructions are further configured to facilitate a transaction based at least in part on the received food request.

10. The server of claim 9, wherein the transaction comprises at least one from the following transaction schemes: a money payment for food, a credit payment for food, and an in-kind payment for food.

11. A server comprising non-transitory computer-readable instructions configured to:
receive a food preparation inquiry; and
provide, based at least in response to the food preparation inquiry, food preparation information.

12. The server of claim 11, wherein:
the food preparation inquiry comprises a search for food preparation resources; and
the search for food preparation resources comprises at least one parameter from the following food preparation resource parameters: location, size, availability time, equipment, and cost.

13. The server of claim 11, wherein:
food preparation information comprises at least a first resource option; and
the first resource option comprises at least one from the following resource options: human resource availability and facility availability.

14. The server of claim 13, wherein:
facility availability comprises inventory options; and
inventory options comprise an option to order preparation inventory comprising ingredients and/or equipment for food preparation.

15. The server of claim 11, wherein human resource availability comprises availability options for hiring humans to assist with food preparation.

16. The server of claim 11, wherein the computer-readable instructions are further configured to receive a resource request comprising a selection based on the provided food preparation information.

17. The server of claim 11, wherein the computer-readable instructions are further configured to receive resource availability input.

18. The server of claim 17, wherein the resource availability input comprises at least one the following inputs: facility information and human resource information.

19. The server of claim 17, wherein facility information comprises location, time availability, equipment, and cost.

20. The server of claim 17, wherein human resource information comprises, for a first person, skill, availability, and cost.
